(19) United States
(12) Patent Application Publication
(10) Pub. No.: US 2007/0042860 A1
(43) Pub. Date: Feb. 22, 2007

(54) Tapered gear tooth apparatus and method

(76) Inventors: Matthieu Rihn, Lingolsheim (FR); Vincent Fruteau De Laclos, Gerstheim (FR); Olivier Schwartz, Strasbourg (FR); Daniel Lips, Geispolsheim (FR); Romain Rondio, Illkirch (FR)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/402,553

(22) Filed: Apr. 12, 2006

Related U.S. Application Data
(60) Provisional application No. 60/709,852, filed on Aug. 19, 2005.

(51) Int. Cl. F16H 57/08

(52) U.S. Cl. 475/344

(57) ABSTRACT

The present invention provides a tapered gear tooth apparatus and method. According to a preferred embodiment, the apparatus includes a generally annular internal gear having a plurality of internal gear teeth. The internal gear teeth define a generally tapered cross section. The apparatus further includes a generally annular external gear having a plurality of external gear teeth. The external gear teeth define a generally parallel cross section. The external gear teeth engage the internal gear teeth of the internal gear such that the external gear teeth are aligned with the internal gear teeth when a positive or negative input torque is applied.

### CROSS-REFERENCE TO RELATED APPLICATIONS

This application claims priority to U.S. Provisional Patent Application No. 60/709852 filed on Aug. 19, 2005, and which is hereby incorporated by reference in its entirety.

### TECHNICAL FIELD

The present invention is drawn to a tapered gear tooth apparatus and method for a planetary gearset.

### BACKGROUND OF THE INVENTION

When a planetary gearset is under load, even under light load in the context of generally experienced gear noise situations, the planet carrier may deflect and the planet pinion bearings, which are not perfectly rigid, may become slightly displaced. As a result, the gears of a planetary gearset may not remain perfectly parallel under load. In other words, gears that perfectly mesh in theory may, under actual working conditions, contact each other at a point that is not centered in the middle of the tooth flank. This misalignment can shift the load distribution on a gear tooth thereby increasing gear noise and reducing durability.

### SUMMARY OF THE INVENTION

The present invention provides a tapered gear tooth apparatus. According to a preferred embodiment, the apparatus includes a generally annular internal gear having a plurality of internal gear teeth. The internal gear teeth define a generally tapered cross section. That is, left flank and right flank helixes of each internal tooth are non-parallel. The apparatus further includes a generally annular external gear having a plurality of external gear teeth. The external gear teeth define a generally parallel cross section. That is, left flank and right flank helixes of each external tooth are generally parallel. The external gear teeth engage the internal gear teeth of the internal gear such that the external gear teeth are aligned with the internal gear teeth when a positive or negative input torque is applied. According to an alternate embodiment, the internal gear teeth are generally parallel and the external gear teeth are tapered.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of an external gear engaged with an internal gear according to the present invention;

FIG. 2a is sectional diagram, along the pitch cylinders of both external and internal gears, showing a prior art gear tooth configuration with no load applied to the gear teeth;

FIG. 2b is sectional diagram, along the pitch cylinders of both external and internal gears, showing a prior art gear tooth configuration when positive input torque is applied to the gear teeth;

FIG. 2c is sectional diagram, along the pitch cylinders of both external and internal gears, showing a prior art gear tooth configuration when negative input torque is applied to the gear teeth;

FIG. 3a is sectional diagram, along the pitch cylinders of both external and internal gears, showing a gear tooth configuration according to a preferred embodiment with no load applied to the gear teeth;

FIG. 3b is sectional diagram, along the pitch cylinders of both external and internal gears, showing a gear tooth configuration according to the preferred embodiment of FIG. 3a when positive input torque is applied to the gear teeth;

FIG. 3c is sectional diagram, along the pitch cylinders of both external and internal gears, showing a gear tooth configuration according to the preferred embodiment of FIG. 3a when negative input torque is applied to the gear teeth;

FIG. 4a is sectional diagram, along the pitch cylinders of both external and internal gears, showing a gear tooth configuration according to an alternate embodiment with no load applied to the gear teeth;

FIG. 4b is sectional diagram, along the pitch cylinders of both external and internal gears, showing a gear tooth configuration according to the alternate embodiment of FIG. 4a when positive input torque is applied to the gear teeth; and

FIG. 4c is sectional diagram, along the pitch cylinders of both external and internal gears, showing a gear tooth configuration according to the alternate embodiment of FIG. 4a when negative input torque is applied to the gear teeth;

### DESCRIPTION OF THE PREFERRED EMBODIMENTS

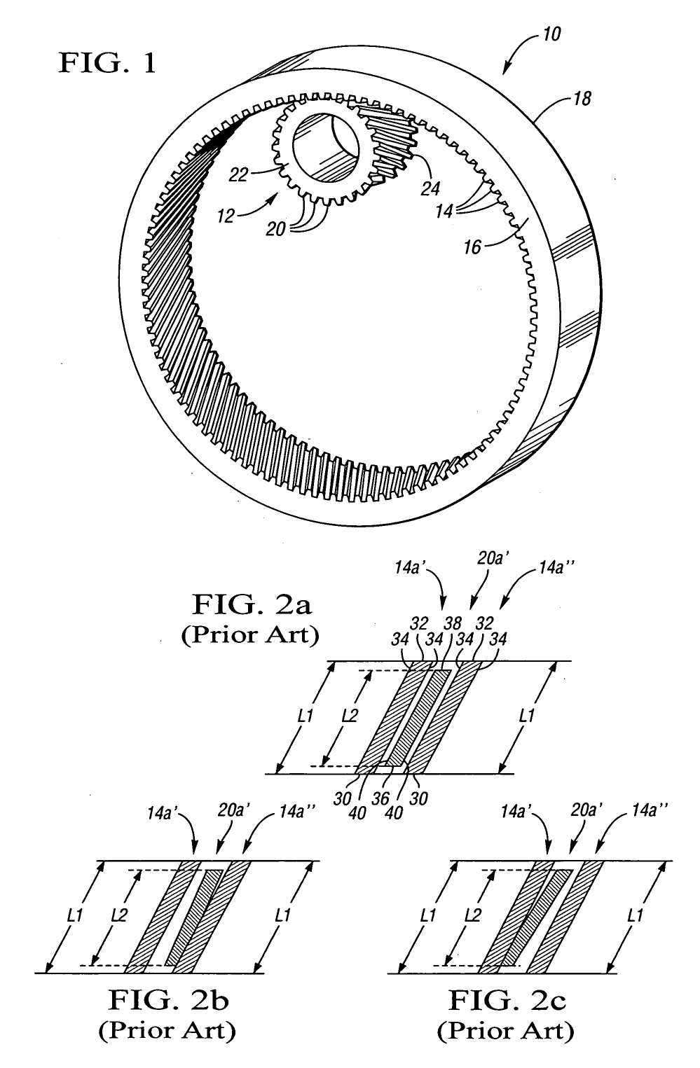

Referring to the drawings, FIG. 1 shows an internal gear 10 and an external gear 12 according to the present invention. According to a preferred embodiment, the internal gear 10 is a ring gear member of a planetary gear set, and the external gear 12 is a planet gear member (pinion) of a planetary gear set. The internal gear 10 is generally annular and includes a plurality of internally disposed gear teeth 14. The internal gear 10 also includes a front face portion 16 and a rear face portion 18. The external gear 12 is generally annular and includes a plurality of externally disposed gear teeth 20. The external gear 12 also includes a front face portion 22 and a rear face portion 24.

Referring to FIG. 2a, a sectional view of a conventional internal gear engaged with a conventional external gear is shown. The sectional view is shown with no load applied to the gears. Like reference numbers are used in FIGS. 2a-c to refer to like components from FIG. 1. For example, the suffix “a” added to a reference numeral identifies a similar component in a different embodiment. The sectional view of FIG. 2a shows a gear tooth 20a′ disposed between gear teeth 14a′ and 14a″.

The gear teeth 14a′ and 14a″ each include a first end portion 30, a second end portion 32, and opposing side portions or flanks 34. The first end portion 30 is generally parallel to the second end portion 32, and the opposing side portions 34 are generally parallel to each other, such that the sectional view of the teeth 14a′ and 14a″ shown in FIG. 2a define a parallelogram. The side portions 34 define a length L1 of the gear teeth 14a′ and 14a″.

The gear tooth 20a′ includes a first end portion 36, a second end portion 38, and opposing side portions or flanks 40. The first end portion 36 is generally parallel to the second end portion 38, and the opposing side portions 40 are generally parallel to each other, such that the sectional view of the tooth 20a′ shown in FIG. 2a defines a parallelogram. The side portions 40 define a length L2 of the gear tooth 20a′. As shown in FIG. 2a, when there is no load applied to the gears, the gear teeth 14a′, 20a′, and 14a″ are generally parallel to each other. For purposes of this disclosure, gear teeth are considered parallel and aligned when their adjacent side portions (such as side portions 34 and 40) are parallel.

It should be appreciated that the parallel gear tooth alignment shown in FIG. 2a is desirable to minimize noise and maximize durability. When such parallel aligned gears engage, the force transferred therebetween is distributed over the entire length L2 of the gear tooth 20a′ as it engages either the gear tooth 14a′ or the gear tooth 14a″. Additionally, the force is generally evenly distributed over the length L1 of the gear tooth 14a′ or the gear tooth 14a″ such that the peak force is located approximately halfway between the first end portion 30 and the second end portion 32. It has been observed that by distributing the transferred force over a larger contact area and by centralizing the force applied to the gear teeth, noise is minimized and durability is maximized.

It has also been observed that, when the gears are under load, the planet carrier (not shown) may deflect and the planet pinion bearings (not shown) may become slightly constrained such that the gear tooth 20a′ of the conventional external gear may be shifted or tilted. As a result of this tilting, the teeth 14a′, 20a′, and 14a″ can become misaligned under load.

As shown in FIG. 2b, when a positive input torque such as would be experienced during a drive condition is transferred between conventional internal and external gears, the teeth 20a′ and 14a″ become misaligned. More precisely, the tooth 20a′ is tilted such that the teeth 20a′ and 14a″ are no longer parallel, and only a portion of the tooth 20a′ engages the tooth 14a″. Therefore, the force transmitted between the teeth 20a′ and 14a″ is distributed over a smaller contact area, and the force is not centralized across the length L1 of tooth 14a″. Accordingly, noise is not minimized and durability is not maximized.

As shown in FIG. 2c, when a negative input torque such as would be experienced during a coast condition is transferred between conventional internal and external gears, the teeth 20a′ and 14a′ become misaligned. More precisely, the tooth 20a′ is tilted such that the teeth 20a′ and 14a′ are no longer parallel, and only a portion of the tooth 20a′ engages the tooth 14a′. Therefore, the force transmitted between the teeth 20a′ and 14a′ is distributed over a smaller contact area, and the force is not centralized across the length L1 of tooth 14a′. Accordingly, noise is not minimized and durability is not maximized.

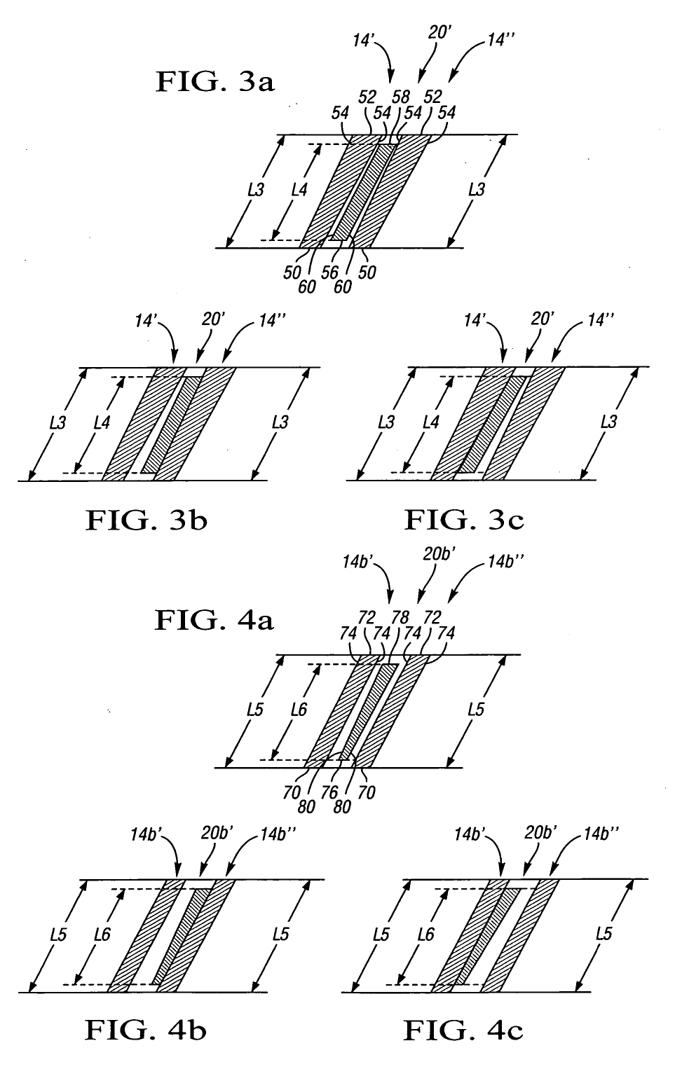

Referring to FIG. 3a, a sectional view shows a gear tooth 20′ disposed between gear teeth 14′ and 14″ when there is no load being applied to the gears 10, 12 (shown in FIG. 1). Like reference numbers are used in FIGS. 3a-c to refer to like components from FIG. 1.

The gear teeth 14′ and 14″ each include a first end portion 50, a second end portion 52, and opposing side portions or flanks 54. The gear teeth 14′ and 14″ are tapered, which means that the opposing side portions 54 of each tooth 14′, 14″ have non-parallel helixes. According to the preferred embodiment, the first end portion 50 is generally parallel to the second end portion 52. Additionally, the second end portion 52 is wider than the first end portion 52 such that opposing side portions 54 taper inward from back to front. The tapered configuration of the side portions 54 in combination with the parallel first and second end portions 50, 52 are generally configured to define a trapezoidal cross section for the teeth 14 as shown in FIG. 3a. The side portions 54 define a length L3 of the gear teeth 14′ and 14″.

The gear tooth 20′ includes a first end portion 56, a second end portion 58, and opposing side portions 60. The gear tooth 20′ is generally parallel, which means that the opposing side portions 60 of the tooth 20′ have parallel helixes. As shown in FIG. 3a, the first end portion 56 is generally parallel to the second end portion 58, and the opposing side portions 60 are generally parallel to each other, such that the sectional view of the tooth 20′ defines a parallelogram. The side portions 60 define a length L4 of the gear tooth 20′.

As shown in FIG. 3a, when there is no load applied to the gears 10, 12 (shown in FIG. 1), the gear teeth 14′, 20′, and 14″ are not parallel to each other. It should be appreciated, however, that noise and durability are less important considerations when there is no load applied to the gears 10, 12 such that the misalignment of the teeth 14′, 20′, and 14″ is generally not problematic.

As shown in FIG. 3b, when a positive input torque such as would be experienced during a drive condition is transferred between the gears 10 and 12 (shown in FIG. 1), the gear teeth 20′ and 14″ become aligned such that they are parallel. The alignment of the gear teeth 20′ and 14″ is attributable to the deflection of the planet carrier (not shown) caused by the transfer of the positive input torque. The deflection of the planet carrier (not shown) is transferred to the external gear 12 thereby causing the teeth 20 to tilt and bringing the gear teeth 20′ and 14″ into alignment. In other words, the amount of taper of the side portions 54 of the gear tooth 14″ is selected to compensate for the tilting of the gear tooth 20′ during the application of positive input torque. As the gear teeth 20′ and 14″ are aligned when positive input torque is applied, the entire length L4 of the gear tooth 20′ contacts the gear tooth 14″ during engagement. Therefore, the force transmitted between the gear teeth 20′ and 14″ is distributed over the entire length L4 of the gear tooth 20′ as it engages the gear tooth 14″. Additionally, the force is generally evenly distributed over the length L3 of the gear tooth 14″ such that the peak force is located approximately halfway between the first end portion 50 and the second end portion 52. Accordingly, noise is minimized and durability is maximized.

As shown in FIG. 3c, when a negative input torque such as would be experienced during a coast condition is transferred between the gears 10 and 12 (shown in FIG. 1), the gear teeth 20′ and 14′ become aligned. The alignment of the gear teeth 20′ and 14′ is similar to that described hereinabove with respect to gear teeth 20′ and 14″ of FIG. 3b, however, since the input torque is negative, the deflection of the planet carrier (not shown) brings the gear tooth 20′ into alignment with gear tooth 14′ instead of the gear tooth 14″. As the gear teeth 20′ and 14′ are aligned when negative input torque is applied, the entire length L4 of the gear tooth 20′ contacts the gear tooth 14′ during engagement. Therefore, the force transmitted between the gear teeth 20′ and 14′ is distributed over the entire length L4 of the gear tooth 20′ as it engages the gear tooth 14′. Additionally, the force is generally evenly distributed over the length L3 of the gear tooth 14′ such that the peak force is located approximately halfway between the first end portion 50 and the second end portion 52. Accordingly, noise is minimized and durability is maximized.

According to an alternate embodiment of the present invention shown in FIG. 4a, the teeth 14 of the internal gear 10 are generally parallel and the teeth 20 of the external gear 12 are tapered to accommodate deflection of the planet carrier (not shown) as will be described in detail hereinafter. Like reference numbers are used in FIGS. 4a-c to refer to like components from FIG. 1. For example, the suffix “b” added to a reference numeral identifies a similar component in a different embodiment. The sectional view of FIG. 4a depicts a gear tooth 20b′ of the external gear 12 (shown in FIG. 1) disposed between consecutive gear teeth 14b′ and 14b″ of the internal gear 10 (shown in FIG. 1) with no load applied to the gear teeth 14b′, 20b′, and 14b″.

The gear teeth 14b′, 14b″ each include a first end portion 70, a second end portion 72, and opposing side portions 74. The gear teeth 14b′ and 14b″ are each generally parallel, which means that the opposing side portions 74 of each tooth 14b′, 14b″ have parallel helixes. Referring to FIG. 4a, the first end portion 70 is generally parallel to the second end portion 72, and the opposing side portions 74 are generally parallel to each other, such that the sectional view of the teeth 14b′, 14b″ defines a parallelogram. The side portions 74 define a length L5 of the gear teeth 14b′, 14b″.

The gear tooth 20b′ includes a first end portion 76, a second end portion 78, and opposing side portions 80. The gear tooth 20b′ is tapered, which means that the opposing side portions 80 of the tooth 20b′ has non-parallel helixes. According to the alternate embodiment, the first end portion 76 is generally parallel to the second end portion 78. Additionally, the second end portion 78 is wider than the first end portion 76 such that opposing side portions 80 taper inward from back to front. The tapered configuration of the side portions 80 in combination with the parallel first and second end portions 76, 78 generally defines a trapezoidal cross section for the tooth 20b′ as shown in FIG. 4a. The side portions 80 define a length L6 of the gear tooth 20b′.

As shown in FIG. 4a, when there is no load applied to the gears 10, 12 (shown in FIG. 1), the gear teeth 14b′, 20b′, and 14b″ are not parallel to each other. It should be appreciated, however, that noise and durability are less important considerations when there is no load applied to the gears 10, 12 such that the misalignment of the teeth 14b′, 20b′, and 14b″ is generally not problematic.

As shown in FIG. 4b, when a positive input torque such as would be experienced during a drive condition is transferred between the gears 10 and 12 (shown in FIG. 1), the gear teeth 20b′ and 14b″ become aligned. The alignment of the gear teeth 20b′ and 14b″ is similar to that described hereinabove with respect to gear teeth 20′ and 14″ of FIG. 3b, however, according to the alternate embodiment of FIG. 4b, the taper of gear tooth 20b′ is adapted to accommodate the planet carrier deflection. In other words, the amount of taper of the side portions 80 of the gear tooth 20b′ is selected to compensate for the tilting of the gear tooth 20b′ during the application of positive input torque. As the gear teeth 20b′ and 14b″ are aligned when positive input torque is applied, the entire length L6 of the gear tooth 20b′ contacts the gear tooth 14b″ during engagement. Therefore, the force transmitted between the gear teeth 20b′ and 14b″ is distributed over the entire length L6 of the gear tooth 20b′ as it engages the gear tooth 14b″. Additionally, the force is generally evenly distributed over the length L5 of the gear tooth 14b″ such that the peak force is located approximately halfway between the first end portion 70 and the second end portion 72. Accordingly, noise is minimized and durability is maximized.

As shown in FIG. 4c, when a negative input torque such as would be experienced during a coast condition is transferred between the gears 10 and 12 (shown in FIG. 1), the gear teeth 20b′ and 14b′ become aligned. The alignment of the gear teeth 20b′ and 14b′ is similar to that described hereinabove with respect to gear teeth 20b′ and 14b″ of FIG. 4b, however, since the input torque is negative, the deflection of the planet carrier (not shown) brings the gear tooth 20b′ into alignment with gear tooth 14b′ instead of gear tooth 14b″. As the gear teeth 20b′ and 14b′ are aligned when negative input torque is applied, the entire length L6 of the gear tooth 20b′ contacts the gear tooth 14b′ during engagement. Therefore, the force transmitted between the gear teeth 20b′ and 14b′ is distributed over the entire length L6 of the gear tooth 20b′ as it engages the gear tooth 14b′. Additionally, the force is generally evenly distributed over the length L5 of the gear tooth 14b′ such that the peak force is located approximately halfway between the first end portion 70 and the second end portion 72. Accordingly, noise is minimized and durability is maximized.

According to another alternate embodiment, the present invention may also be applied to a plurality of engaged external gears (not shown). The sectional views of FIGS. 3a-4c showing an internal gear engaged with an external gear are similar to a sectional view of an external gear engaged with another external gear. Therefore, the sectional views of FIGS. 3a-4c should be referenced in support of this alternate embodiment. According to this embodiment, the teeth of one of the external gears are generally parallel and the teeth of the other external gear are tapered to accommodate deflection. The amount of taper is selected to accommodate the tilting of an external gear when positive or negative torque is applied. In this manner, the teeth of the external gears may be aligned under load so that noise is minimized and durability is maximized.

While the best modes for carrying out the invention have been described in detail, those familiar with the art to which this invention relates will recognize various alternative designs and embodiments for practicing the invention within the scope of the appended claims.

1. A gear member of a planetary gearset comprising:
a front face;
a rear face generally opposite said front face; and
a first plurality of gear teeth disposed axially between front face and the rear face, each of said first plurality of gear teeth including:
a first end portion;
a second end portion generally opposite said first end portion; and
tapered opposing side portions defined between the first and second end portions, said tapered opposing side portions configured such that one of said end portions is narrower than the other of said end portions;
wherein the degree of taper of the opposing side portions is configured to accommodate deflection of the planetary gear set such that when an input torque is applied, the first plurality of gear teeth will become aligned relative to a second plurality of gear teeth with which the first plurality of gear teeth are engaged thereby minimizing gear noise and maximizing the durability of the gear member.

2. The gear member of claim 1, wherein the gear member is an internal gear member of the planetary gear set.

3. The gear member of claim 1, wherein the gear member is an external gear member of the planetary gear set.

4. A gearset having first and second gear teeth, each tooth having loadable side portions in loadable relation to each other; wherein one of said teeth is tiltable with respect to the other of said teeth under load; and wherein one of said teeth is configured sufficiently with respect to the other of said teeth to cause said loadable side portions to come into substantially aligned contact with each other when at least one of said teeth tilts under load.

5. The gearset of claim 4, wherein said one of said teeth is configured with a trapezoidal cross section.

6. The gearset of claim 5, wherein at least one of said loadable side portions is tapered with respect to the other of said side portions.

7. The gearset of claim 6, wherein said gear set is a planetary gear set.

8. A method of reducing gear noise generated in both drive and coast conditions by an automatic transmission using helical gearsets having an internal gear and an external gear in tiltable intermeshing contact with each other and comprising:
tapering at least one of said gears along its length sufficiently to accommodate gear tilt and provide increased contact between the intermeshing gears.

9. The method of claim 8, wherein said at least one gear is said internal gear.

10. The method of claim 8, wherein said at least one gear is said external gear.
